(19) United States
(12) Patent Application Publication
(10) Pub. No.: US 2009/0227714 A1
(43) Pub. Date: Sep. 10, 2009

(54) RESIN COMPOSITION AND SEMICONDUCTOR DEVICE USING THE SAME

(76) Inventors: Hiroyuki Kawakami, Chiba-ken (JP); Takuya Imai, Chiba-ken (JP); Reiko Mashino, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/720,102

(22) PCT Filed: Apr. 18, 2006
(86) PCT No.: PCT/JP2006/008133

§ 371 Date: May 24, 2007

(30) Foreign Application Priority Data
Apr. 19, 2005 (JP) 2005-120985
Jul. 6, 2005 (JP) 2005-198002

(51) Int. Cl. C08K 5/1515; C08L 77/00; C08L 79/08

(52) U.S. Cl. 524/114; 524/500; 524/538

(57) ABSTRACT

PURPOSE: To provide a resin composition excellent in pattern-embedding property, adhesion, heat resistance, flexibility and printability, and a semiconductor device using the same. SOLUTION: The present invention relates to a resin composition comprising (A) an aromatic thermoplastic resin soluble in a polar solvent at room temperature, (B) an aromatic thermoplastic resin not soluble in the polar solvent at room temperature but soluble by heating, (C) a filler having rubber elasticity of which an average particle diameter is 0.1 to 6 μm and a particle diameter distribution is 0.01 to 15 μm and (D) the polar solvent, wherein viscosities of the resin composition measured at frequencies of 5 Hz and 50 Hz under a shear stress of 13 Pa by using a rheometer are less than 400 Pa·s and not less than 3 Pa·s, respectively, and a ratio of those viscosities (viscosity at 5 Hz (Pa·s)/viscosity at 50 Hz (Pa·s)) is not less than 2.

### BACKGROUND OF THE INVENTION

1. Technical Field

The present invention relates to a resin composition excellent in pattern-embedding property, adhesion, heat resistance, flexibility and printability, and to a semiconductor device using the resin composition.

2. Prior Art

Heat resistant resins such as polyimide resins have been widely used in the field of electronics as a surface protection layer and an interlayer insulating layer for a semiconductor element, because of their good heat resistance and mechanical properties. Recently, for forming an image on those polyamide resin layers used as a surface protection layer, an interlayer insulating layer and a stress relaxing material and the like, a screen printing method has gotten an attention, which does not require cumbersome procedures such as exposure, development and etching.

In the screen printingmethod, aheat resistant resin paste having thixotropic property comprising a base resin, a filler and a solvent as components is used. Most of heat resistance resinpastesdevelopedhithertoutilizeamicroparticleof silica or non-soluble polyimide as a filler for imparting thixotropic property, and thus are pointed out problems that much voids and bubbles remain on the interface of filler during heat-drying, and the resulting layer has a reduced strength and inferior electrical insulation property.

Consequently, a heat resistance resin paste has been disclosed, which is free from those problems and can form a polyimide pattern having good characteristics due to that the paste is composed of a particular organic filler (a soluble filler), a base resin and a solvent, wherein the filler is firstly melted upon heat-drying and compatibilized with the base resin to form a layer (see, Japanese Patent Application Laid-Open No. 02-289646). There is alsoatechniqueofaddingalow-elasticity filler and a liquid rubber and the like to the paste to use the paste as a stress relaxing material for a wafer-level CSP (see, WO 01/066645).

However, when using the low-elasticity paste described above as a stress relaxing material for a wafer-level CSP of a metal post type, the paste has poor metal post-embedding property and the finished semiconductor device has decreased reliability, and when using a low-viscosity paste in order to improve metal post-embedding property, shape retention after printing is worsened. Therefore, controlling a viscosity satisfying both of metal post-embedding property and shape retention after printing is required.

### SUMMARY OF THE INVENTION

The object of the invention is to provide a resin composition excellent in pattern-embedding property, adhesion, heat resistance, flexibility and printability, and a semiconductor device using the resin composition.

For solving the problems described above, the present inventors have found that a resin composition can be obtained, which satisfies both of pattern-embedding property and shape retention after printing, and also satisfies characteristics such as adhesion, heat resistance and flexibility, by reducing viscosities of the resin composition measured at frequencies of around 5 Hz and around 50 Hz under a constant shear stress to the extent of the composition having an excellent metal post-embedding property when printing, while expanding a gap between the viscosities measured at frequencies of around 5 Hz and around 50 Hz, and thus accomplished the present invention.

That is, the present invention is characterized by the following (1) to (5):

(1) A resin composition comprising (A) an aromatic thermoplastic resin soluble in a polar solvent at room temperature, (B) an aromatic thermoplastic resin not soluble in the polar solvent at room temperature but soluble by heating, (C) a filler having rubber elasticity of which an average particle diameter is 0.1 to 6 μm and a particle diameter distribution is 0.01 to 15 μm and (D) the polar solvent, wherein viscosities of the resin composition measured at frequencies of 5 Hz and 50 Hz under a shear stress of 13 Pa by using a rheometer are less than 400 Pa·s and not less than 3 Pa·s, respectively, and a ratio of those viscosities (viscosity at 5 Hz (Pa·s)/viscosity at 50 Hz (Pa's)) is not less than 2.

(2) The resin composition according to (1), wherein (A) the aromatic thermoplastic resin soluble in the polar solvent at room temperature and (B) the aromatic thermoplastic resin not soluble in the polar solvent at room temperature but soluble by heating are polyamide resins, polyimide resins, polyamideimide resins or a precursors thereof.

(3) The resin composition according to (1) or (2), wherein the surface of the filler having rubber elasticity is subjected to chemical modification.

(4) The resin composition according to (3), wherein the chemical modification is modification by an epoxy group.

(5) A semiconductor device using the resin composition according to any of (1) to (4).

The resin composition of the present invention is excellent in pattern-embedding property, adhesion, heat resistance, flexibility and printability. Particularly, the resin composition of the present invention satisfies both of conflicting characteristics, pattern-embedding property and shape retention after printing, and therefore a refined and intricate pattern can be formed therewith by known methods such as screen printing and dispense coating. Further, a semiconductor device using the resin composition of the present invention gives good characteristics.

This application claims priority based on Japanese patent applications filed by the applicants of the present application, namely Japanese Patent Application Nos. 2005-120985 (filed on Apr. 19, 2005), the contents of whose specifications are incorporated herein by reference.

### BRIEF DESCRIPTION OF THE DRAWINGS

FIG. 1 shows schematic diagrams of screen printing a resin composition on a semiconductor substrate having a wiring formed thereon: FIG. 1-a is before printing, and FIG. 1-b is after printing. (Reference Numerals: resin composition 1, squeegee 2, printing mask 3, wiring formed part 4, scribing line part 5, silicon wafer 6)

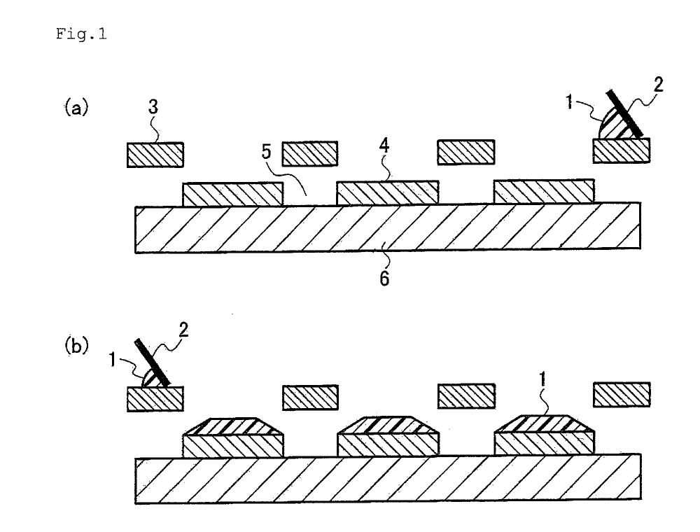

FIG. 2 is a cross-section view of an example of semiconductor package in which the heat resistant resin composition of the present invention is used in a stress relaxing layer. (Reference Numerals: solder ball 11, copper post 12, stress relaxing layer 13, copper wiring 14, silicon wafer 15, polyimide insulating film 16, electrode 17)

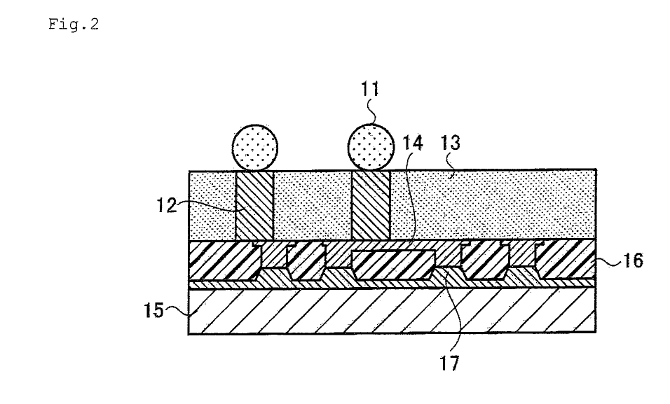

### DESCRIPTION OF THE PREFERRED EMBODIMENT(S)

The resin composition of the present invention comprises (A) an aromatic thermoplastic resin soluble in a polar solvent at room temperature, (B) an aromatic thermoplastic resin not soluble in the polar solvent at room temperature but soluble by heating, (C) a filler having rubber elasticity of which an average particle diameter is 0.1 to 6 μm and a particle diameter distribution is 0.01 to 15 μm and (D) the polar solvent, and is characterized by that viscosities of the resin composition measured at frequencies of 5 Hz and 50 Hz under a shear stress of 13 Pa by using a rheometer are less than 400 Pa·s and not less than 3 Pa·s, respectively, and a ratio of those viscosities (viscosity at 5 Hz (Pa·s)/viscosity at 50 Hz (Pa·s)) is not less than 2. According to the present invention, a resin composition excellent in pattern-embedding property, adhesion, heat resistance, flexibility and printability, and a semiconductor device using the resin composition can be provided.

In the present invention, a viscosity measured at 5 Hz under a shear stress of 13 Pa by using a rheometer is necessary to be less than 400 Pa·s, and is preferably less than 280 Pa·s, more preferably less than 250 Pa·s, still more preferably less than 220 Pa·s, and especially preferably less than 200 Pa·s. A viscosity of not less than 400 Pa·s measured at 5 Hz leads to a tendency of decreased property of embedding a pattern such as a metal post. A viscosity measured at 50 Hz under the same conditions is also necessary to be 3 Pa·s or more, and is preferably 6 Pa·s or more, more preferably 9 Pa·s or more, and especially preferably 12 Pa·s or more. A viscosity of less than 3 Pa·s measured at 50 Hz leads to a tendency of inferior shape retention after printing. Moreover, a ratio of the viscosity measured at 5 Hz to the viscosity measured at 50 Hz (viscosity at 5 Hz (Pa·s)/viscosity at 50 Hz (Pa·s)) is necessary to be 2 or more, and is preferably 2.1 or more, more preferably 2.2 or more, still more preferably 2.3 or more, and especially preferably 2.4 or more. When the ratio is less than 2, simultaneous pursuit of a property of embedding a pattern such as a metal post and shape retention after printing tends to be difficult.

Viscosities at those frequencies can be controlled by modifying a nonvolatile matter concentration (hereinafter, referred to as NV) in the resin composition and/or a molecular weight of (A) an aromatic thermoplastic resin soluble in a polar solvent at room temperature or (B) an aromatic thermoplastic resin not soluble in the polar solvent at room temperature but soluble by heating and the like. Specifically, the smaller the NV or the molecular weight of those aromatic thermoplastic resins is, the more decreased viscosities at those frequencies are.

The viscosities can be measured at room temperature by using a rheometer (a dynamic elasticity measuring apparatus), including, for example, a rheometer model CSR-10 manufactured by BOHLIN INSTRUMENTS and the like.

(A) An aromatic thermoplastic resin soluble in a polar solvent at room temperature and (B) an aromatic thermoplastic resin not soluble in the polar solvent at room temperature but soluble by heating in the present invention are not specifically limited, but preferably polyamide resins, polyimide resins, polyamideimide resins or precursors thereof. Particularly, it is desirable that (B) component imparts thixotropy to the resin composition of the present invention to allow it to form a refined pattern by screen printing, dispense coating and the like. The term “room temperature” as used herein refers a temperature condition as allowing to stand in a room without specific setting or controlling of a solvent temperature, and is preferably, but not limited to, within the range of 10 to 40° C. The term “heating” means to increase a temperature of a solvent to not less than 80° C., more preferably 80 to 200° C., and still more preferably 100 to 180° C. When heating to less than 80° C., (C) a filler tends to be dispersed insufficiently and the resultant coating tends to have decreased surface flatness.

Polyamide resins, polyimide resins, polyamideimide resins or precursors thereof described above may be prepared according to a known method, for example, of reacting an aromatic, aliphatic, or alicyclic diamine compound with a dicarboxylic acid or a reactive acid derivative thereof and/or a tricarboxylic acid or a reactive acid derivative thereof and/or a tetracarboxylic dianhydride. The method may be appropriately selected according to reactivities of those starting materials and the like. The method may be carried out without solvent or in the presence of an organic solvent. A reaction temperature is preferably set to 25° C. to 250° C., and a period of reaction may be appropriately selected according to a batch scale, reaction conditions employed and the like.

The organic solvent used in producing (A) component and (B) component described above is not specifically limited, including, for example, ether solvents such as diethylene glycol dimethyl ether, diethylene glycol diethyl ether, triethylene glycol dimethyl ether and triethylene glycol diethyl ether; sulfur-containing solvents such as dimethylsulfoxide, diethylsulfoxide, dimethylsulfone and sulfolane; ester solvents such as γ-butyrolactone and cellosolve acetate; ketone solvents such as cyclohexanone and methylethylketone; nitrogen-containing solvents such as N-methylpyrrolidone, dimethylacetamide and 1,3-dimethyl-3,4,5,6-tetrahydro-2(1H)-pyrimidinone; and aromatic hydrocarbon-based solvents such as toluene and xylene. Those may be used alone or in combination, and preferably selected to dissolve the resultant resin.

A general method for preparing a polyimide resin or a polyamideimide resin from a polyimide resin precursor or a polyamideimide resin precursor, respectively, through dehydrocyclization may also be used without specific limitation.

For example, a thermal cyclization method of dehydrocyclizing by heating under an atmosphere or reduced pressure, a chemical cyclization method using a dehydrating agent such as acetic anhydride in the presence or absence of a catalyst, and the like may be used.

In the case of the thermal cyclization method, a reaction is preferably conducted with removing water resulting from a dehydration reaction off. The removal is conducted by heating a reaction mixture to 80 to 400° C., and preferably to 100 to 250° C. In this operation, water may be azeotropically removed by using together with a solvent azeotropic with water such as, benzene, toluene and xylene.

In the case of the chemical cyclization method, a reaction is conducted in the presence of a chemical dehydrating agent at 0 to 120° C. and preferably at 10 to 80° C. As the chemical dehydrating agent, for example, acid anhydrides such as acetic anhydride, propionic anhydride, butyric anhydride and benzoic anhydride, carbodiimide compounds such as dicyclohexylcarbodiimide and the like are preferably used. In the reaction, a substance that promotes the cyclization reaction such as pyridine, isoquinoline, trimethylamine, triethylamine, aminopyridine and imidazole is preferably used together. The chemical dehydrating agent is used in an amount of 90 of 600% by mole of the total amount of the diamine compound, and the substance that promotes the cyclization reaction agent is used in an amount of 40 to 300% by mole of the total amount of the diamine compound. Dehydrating catalysts may also be used, which are, for example, phosphorus compounds such as triphenyl phosphite, tricyclohexyl phosphite, triphenyl phosphate, phosphoric acid and phosphorus pentoxide, and boron compounds such as boric acid and boric anhydride and the like.

After the imidation is completed by dehydration, the reaction mixture is poured into a large excess volume of solvent such as a lower alcohol (e.g., methanol), water, or a mixture thereof, which is compatible with the organic solvent described above and is poor for the resin, to give a precipitate of the resin, which is filtered and dried to give a polyimide resin or a polyamideimide resin. In view of reduction of remaining ionic impurity, the former thermal cyclization method is preferable.

In the resin composition of the present invention, respective contents of (A) component and (B) component described above are not specifically limited and may be any amounts, but preferably are amounts such that (B) component is 10-300 parts by weight relative to 100 parts by weight of (A) component, and more preferably amounts such that (B) component is 10 to 200 parts by weight relative to 100 parts by weight of (A) component. When a content of (B) component is less than 10 parts by weight, thixotropic property of the resultant resin composition tends to be reduced, and when more than 300 parts by weight, properties of the resultant coating tends to be worsened.

(C) The filler having rubber elasticity in the present invention is not specifically limited as long as it can reduce an elastic modulus of the resin composition, including elastic fillers such as an acrylic rubber, a fluorine rubber, a silicone rubber and a butadiene rubber and liquid rubbers thereof. In view of heat resistance of the resin composition of the present invention, a silicone rubber is preferable, and for example, TREFIL E series (trade name, manufactured by Dow Corning Toray Silicone Co., Ltd.) may be used. An average particle diameter of (C) component is preferably 0.1 to 6 μm, more preferably 0.2 to 5 μm, and especially preferably 0.3 to 4 μm. When an average particle diameter is less tha n0.1 μm, particles tend to aggregate each other, and the filler may be difficult to be dispersed. When over 6 μm, a filtration step is difficult to be introduced, and surface flatness of the resultant coating tends to be worsened. A shape thereof is preferably spherical or irregular microparticle. Further, a particle diameter distribution of (C) component is preferably 0.01 to 15 μm, more preferably 0.02 to 15 μm, and especially preferably 0.03 to 15 μm. When there is a particle having a particle diameter of less than 0.01 μm, particles may easily aggregate each other, and the filler may be difficult to be dispersed sufficiently. When there is a particle having a particle diameter of more than 15 μm, a filtration step is difficult to be introduced, and surface flatness of the resultant coating tends to be worsened.

The surface of the filler as (C) component is preferably subjected to chemical modification with a functional group. Examples of the functional group include an epoxy group, an amino group, an acryl group, a vinyl group, a phenyl group and the like. Preferred is an epoxy group. For example, a silicone rubber of TREFIL E-601 in the TREFIL E series has a modified surface with an epoxy group, and is suitable for (C) component.

In addition, (C) component is preferably used in an amount of 5 to 900 parts by weight, and more preferably 5 to 800 parts by weight, relative to 100 parts by weight of the total aromatic thermoplastic resins comprising (A) component and (B) component. Addition of such (C) filler to the thermoplastic resin having heat resistance allows the thermoplastic resin to have low-elasticity without impairing heat resistance and adhesion thereof and to control an elastic modulus thereof.

In the present invention, (D) a polar solvent can be any solvent composed of a polar molecule without specific limitation, including, for example, nitrogen-containing compounds such as N-methylpyrrolidone, dimethylacetamide, dimethylformamide and 1,3-dimethyltetrahydro-2(1H)-pyrimidinone; sulfur-containing compounds such as sulfolane and dimethylsulfoxide; lactones such as γ-butyrolactone, γ-valerolactone, γ-caprolactone, γ-heptalactone, α-acetyl-γ-butyrolactone and ε-caprolactone; ketones such as methylethylketone, methylisobutylketone, cyclohexanone and acetophenone; ethers such as ethylene glycol, glycerol, diethylene glycol dimethyl ether, diethylene glycol diethyl ether, diethylene glycol dipropyl ether, diethylene glycol dibutyl ether, triethylene glycol dimethyl ether, triethylene glycol diethyl ether, triethylene glycol dipropyl ether, triethylene glycol dibutyl ether, tetraethylene glycol dimethyl ether, tetraethylene glycol diethyl ether, tetraethylene glycol dipropyl ether, tetraethylene glycol dibutyl ether, diethylene glycol monomethyl ether, diethylene glycol monoethyl ether, triethylene glycol monomethyl ether, triethylene glycol monoethyl ether, tetraethylene glycol monomethyl ether and tetraethylene glycol monoethyl ether; and the like.

An amount of (D) component added may be appropriately determined in consideration with a viscosity of the resin composition of the present invention without specific limitation, but is preferably 100 to 3500 parts by weight and more preferably 150 to 1000 parts by weight, relative to 100 parts by weight of the total resins in the resin composition of the present invention.

In addition, the resin composition of the present invention may be added with additives such as a colorant and a coupling agent, and a resin modifier according to need. Examples of the colorant include a carbon black, dyes and pigments. Examples of the coupling agent include silane-based, titanium-based and aluminum-based agents. Silane-based coupling agents are most preferable.

Silane-based coupling agents are not specifically limited, including, for example, vinyltrichlorosilane, vinyl tris(β-methoxyethoxy)silane, vinyltriethoxysilane, vinyltrimethoxysilane, γ-methacryloxypropyltrimethoxysilane, γ-methacryloxypropylmethyldimethoxysilane, β-(3,4-epoxycyclohexyl)ethyltrimethoxysilane, γ-glycidoxypropyltrimethoxysilane, γ-glycidoxypropylmethyldimethoxysilane, γ-glycidoxypropylmethyldiethoxysilane, N-β(aminoethyl) γ-aminopropyltrimethoxysilane,

N-β(aminoethyl) γ-aminopropylmethyldimethoxysilane, γ-aminopropyltriethoxysilane, N-phenyl-γ-aminopropyltrimethoxysilane, γ-mercaptopropyltrimethoxysilane, γ-mercaptopropyltriethoxysilane, 3-aminopropylmethyldiethoxysilane, 3-ureidopropyltriethoxysilane, 3-ureidopropyltrimethoxysilane, 3-aminopropyltrimethoxysilane, 3-aminopropyl-tris(2-methoxy-ethoxy-ethoxy)silane, N-methyl-3-aminopropyltrimethoxysilane, triaminopropyl-trimethoxysilane, 3-4,5-dihydroimidazol-1-yl-propyltrimethoxysilane, 3-methacryloxypropyl-trimethoxysilane, 3-mercaptopropyl-methyldimethoxysilane, 3-chloropropyl-methyldimethoxysilane, 3-chloropropyl-dimethoxysilane, 3-cyanopropyl-triethoxysilane, hexamethyldisilazane, N,O-bis(trimethylsilyl)acetamide, methyltrimethoxysilane, methyltriethoxysilane, ethyltrichlorosilane, n-propyltrimethoxysilane, isobutyltrimethoxysilane, amyltrichlorosilane, octyltriethoxysilane, phenyltrimethoxysilane, phenyltriethoxysilane, methyltri(methacryloyloxyethoxy)silane, methyltri (glycidyloxy)silane,
N-β(N-vinylbenzylaminoethyl)-γ-aminopropyltrimethoxysilane, octadecyldimethyl[3-(trimethoxysilyl)propyl]ammonium chloride, γ-chloropropylmethyldichlorosilane, γ-chloropropylmethyldimethoxysilane, γ-chloropropylmethyldiethoxysilane, trimethylsilyl isocyanate, dimethylsilyl isocyanate, methylsilyl triisocyanate, vinylsilyl triisocyanate, phenylsilyl triisocyanate, tetraisocyanate silane, ethoxysilane isocyanate and the like. Those may be used alone or in combination.

Titanium-based coupling agents are not specifically limited, including, for example, isopropyltrioctanoyl titanate, isopropyldimethacrylisostearoyl titanate, isopropyltridodecylbenzenesulfonyl titanate, isopropylisostearoyldiacryl titanate, isopropyltri(dioctyl phosphate)titanate, isopropyltricumylphenyl titanate, isopropyltris(dioctyl pyrophosphate)titanate, isopropyltris(n-aminoethyl)titanate, tetraisopropylbis(dioctyl phosphite)titanate, tetraoctylbis(ditridecyl phosphite)titanate, tetra(2,2-diallyloxymethyl-1-butyl)bis(ditridecyl)phosphite titanate, dicumylphenyloxyacetate titanate, bis(dioctyl pyrophosphate) oxyacetate titanate, tetraisopropyl titanate, tetra-n-butyl titanate, butyl titanate dimer, tetra(2-ethylhexyl)titanate, titanium acetylacetonate, polytitanium acetylacetonate, titanium octyleneglycolate, titanium lactate ammonium salt, titanium lactate, titanium lactate ethyl ester, titanium triethanolaminate, polyhydroxytitanium stearate, tetramethyl ortho titanate, tetraethyl ortho titanate, tetrapropyl orthotitanate, tetraisobutyl orthotitanate, stearyl titanate, cresyl titanate monomer, cresyl titanate polymer, diisopropoxy-bis(2,4-pentadionate)titanium (IV), diisopropyl-bis-triethanolamino titanate, octylene glycol titanate, tetra-n-butoxytitanium polymer, tri-n-butoxytitanium monostearate polymer, tri-n-butoxytitanium monostearate and the like. Those may be used alone or in combination.

Aluminum-based coupling agents are not specifically limited, including, for example, aluminumchelate compounds such as ethyl acetoacetate aluminum diisopropylate, aluminum tris (ethyl acetoacetate), alkyl acetoacetate aluminum diisopropylate, aluminum monoacetylacetate bis(ethyl acetoacetate), aluminum tris(acetylacetonate), aluminium=monoisopropoxymonooleoxyethylacetoacetate, aluminium-di-n-butoxide-mono-ethylacetoacetate and aluminium-di-iso-propoxide-mono-ethylacetoacetate; and aluminum alcoholates such as aluminum isopropylate, mono-sec-butoxyaluminum diisopropylate, aluminium-sec-butylate and aluminum ethylate; and the like. Those may be used alone or in combination.

The additive described above is preferably added in an amount of not more than 50 parts by weight relative to 100 parts by weight of the total aromatic thermoplastic resin comprising (A) component and (B) component. When an amount of the additive added is more than 50 parts by weight, properties of the resultant coating tend to be worsened.

The resin composition of the present invention may be added with a radiation-polymerizable compound.

Radiation-polymerizable compounds are not specifically limited, including, for example, methyl acrylate; methyl methacrylate; ethyl acrylate; ethyl methacrylate; butyl acrylate; butyl methacrylate; 2-ethylhexyl acrylate; 2-ethylhexyl methacrylate; pentenyl acrylate; tetrahydrofurfuryl acrylate; tetrahydrofurfuryl methacrylate; diethylene glycol diacrylate; triethylene glycol diacrylate; tetraethylene glycol diacrylate; diethylene glycol dimethacrylate; triethylene glycol dimethacrylate; tetraethylene glycol dimethacrylate; trimethylolpropane diacrylate; trimethylolpropane triacrylate; trimethylolpropane dimethacrylate; trimethylolpropane trimethacrylate; 1,4-butanediol diacrylate; 1,6-hexanediol diacrylate; 1,4-butanediol dimethacrylate; 1,6-hexanediol dimethacrylate; pentaerythritol triacrylate; pentaerythritol tetraacrylate; pentaerythritol trimethacrylate; pentaerythritol tetramethacrylate; dipentaerythritol hexaacrylate; dipentaerythritol hexamethacrylate; styrene; divinylbenzene; 4-vinyltoluene; 4-vinylpyridine; N-vinylpyrrolidone; 2-hydroxyethyl acrylate; 2-hydroxyethyl methacrylate; 1,3-acryloyloxy-2-hydroxypropane; 1,2-methacryloyloxy-2-hydroxypropane; methylene bisacrylamide; N,N-dimethylacrylamide; N-methylol acrylamide; triacrylate of tris(β-hydroxyethyl)isocyanurate; compounds represented by the formula (I),

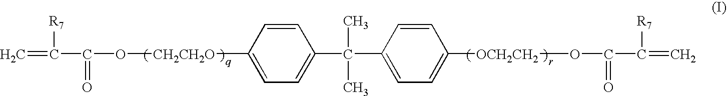

(wherein, R₇ is a hydrogen or methyl group, and q and r are integers of not less than 1); diols; isocyanate compounds represented by the formula (II),

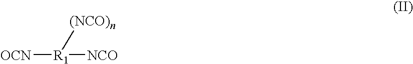

(wherein, n is an integer from 0 to 1, and R₁ is a divalent or trivalent organic group having 1 to 30 carbon atoms); urethane (meth)acrylate consisting of a compound represented by the formula (III),

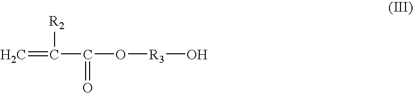

(wherein, R₂ is a hydrogen or methyl group, and R₃ is an ethylene or propylene group); diamines represented by the formula (IV),

H₂N—R₁—NH₂ (IV)

(wherein, R₁ represents an organic group having 2 to 30 carbon atoms); urea methacrylate consisting of a compound represented by the formula (V),

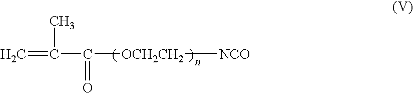

(wherein, n is an integer from 0 to 1); and radiation-polymerizable compounds obtained by an addition reaction of a vinyl copolymer containing a functional group with a compound having at least one ethylenically unsaturated group and at least one functional group such as an oxirane ring, an isocyanate group, a hydroxy group and a carboxy group; and the like. Those may be used alone or in combination.

An amount of the radiation-polymerizable compound used is preferably not more than 50 parts by weight relative to 100 parts by weight of the total aromatic thermoplastic resins comprising (A) component and (B) component. When an amount of the additive added is more than 50 parts by weight, properties of the resultant coating tend to be worsened.

The resin composition of the present invention may also be added with a photoinitiator, which generates a free radical by irradiation with active light. Examples of the photoinitiator include aromatic ketones such as benzophenone, N,N′-tetramethyl-4,4′-diaminobenzophenone (Michler's ketone), N,N′-tetraethyl-4,4′-diaminobenzophenone, 4-methoxy-4′-dimethylaminobenzophenone, 2-benzyl-2-dimethylamino-1-(4-morpholinophenyl)-butanone-1, 2,2-dimethoxy-1,2-diphenylethan-1-one, 1-hydroxy-cyclohexyl-phenyl-ketone, 2-methyl-1-(4-(methylthio)phenyl)-2-morpholinopropanone-1,2,4-diethylthioxanthone, 2-ethylanthraquinone, phenanthrenequinone; benzoin ethers such as benzoin methyl ether, benzoin ethyl ether and benzoin phenyl ether; benzoins such as methylbenzoin and ethylbenzoin; benzyl derivatives such as benzyl dimethyl ketal; 2,4,5-triarylimidazole dimers such as 2-(o-chlorophenyl)-4,5-diphenylimidazole dimer, 2-(o-chlorophenyl)-4,5-di(m-methoxyphenyl)imidazole dimer, 2-(o-fluorophenyl)-4,5-phenylimidazole dimer, 2-(o-methoxyphenyl)-4,5-diphenylimidazole dimer, 2-(p-methoxyphenyl)-4,5-diphenylimidazole dimer, 2,4-di(p-methoxyphenyl)-5-phenylimidazole dimer and 2-(2,4-dimethoxyphenyl)-4,5-diphenylimidazole dimer; acridine derivatives such as 9-phenylacridine and 1,7-bis(9,9′-acridinyl)heptane; and the like. Those may be used alone or in combination. An amount of the photoinitiator used is not specifically limited, but usually 0.01 to 30 parts by weight relative to 100 parts by weight of the radiation-polymerizable compound.

A method for forming a refined pattern with the resin composition of the present invention is not specifically limited, including, for example, screen printing, dispense coating, potting, curtain coating, letterpress printing, intaglio printing, lithography and the like. In view of workability and the like, screen printing or dispense coating is preferable.

A semiconductor device with the resin composition of the present invention is obtained by, for example, applying the resin composition of the present invention or adhering a resin film consisting of the resin composition of the present invention to a substrate or lead frame to form a resin layer, and then attaching a chip on said resin layer. Obviously, a chip may be applied with the resin composition of the present invention or adhered with the resin film consisting of the resin composition of the present invention on the surface thereof, and then be attached to a substrate or lead frame. Applying and drying can be carried out according to a known method. In those steps, imidation does not occur and a step of evaporating a solvent at not more than 250° C. can be employed to obtain a resin layer. The resultant resin layer having a glass transition temperature Tg of not less than 180° C. and a pyrolysis temperature of not less than 300° C. is preferable because it has sufficient heat resistance. In addition, since a tensile elastic modulus of the resin layer is controllable within the range of 0.2 to 3.0 GPa, the resin layer is capable of accommodating all kinds of semiconductor devices.

A semiconductor device with the resin composition of the present invention is, for example, produced by the steps of: applying the resin composition of the present invention on a semiconductor substrate having a plurality of isomorphic wirings formed thereon and drying to form a resin layer; forming a rewiring on the resin layer, which is in electrical communication with an electrode on the semiconductor substrate, according to need; forming a protective layer on the rewiring or the resin layer according to need; forming an external electrode terminal on the protective layer according to need; and dicing according to need. The semiconductor substrate is not specifically limited, and including a silicon wafer and the like. An applying method of the resin layer is not specifically limited, but preferably screen printing or dispense coating. Drying of the resin layer can be carried out according to a known method. In addition, since the resin layer has properties required for forming a rewiring such as sputter resistance, plating resistance and alkaline resistance, it is capable of accommodating all kinds of semiconductor devices. An amount of warpage of a silicon wafer can also be reduced. A semiconductor device produced by this method is expected to be improved in yield, and thus productivity can be improved.

### EXAMPLES

The invention is described in more detail with reference to the following Examples, but should not be limited by those.

### <Preparation of (A) Component and (B) Component>

### Preparation Example 1

In a 0.5-l four-neck flask equipped with a thermometer, a stirrer, a nitrogen introduction tube and a reflux condenser with an oil/water separator, 45.92 g (112 mmol) of 2,2-bis[4-(4-aminophenoxy)phenyl]propane (hereinafter, abbreviated to BAPP) was added with 50 g of N-methyl-2-pyrrolidone (hereinafter, abbreviated to NMP) to dissolve under nitrogen stream. Then, to the reaction mixture was added with 23.576 g (112 mmol) of trimellitic anhydride chloride (hereinafter, abbreviated to TAC) with cooling not to over 20° C. After stirring for an hour at room temperature, to the reaction mixture was added with 13.5744 g (134.4 mmol) of triethylamine (hereinafter, abbreviated to TEA) with cooling not to over 20° C., and reacted for 3 hours at room temperature to produce a polyamic acid varnish. The resultant polyamic acid varnish was further subjected to dehydration reaction for 6 hours at 190° C. to produce a polyamideimide resin varnish. This polyamideimide resin varnish was poured into water and the resultant precipitate was separated, milled and dried to give a polyamideimide resin powder (PAI-1) soluble in a polar solvent at room temperature. The resultant polyamideimide resin (PAI-1) was measured for a weight average molecular weight by using a gel permeation chromatography (hereinafter, abbreviated to GPC) based on a polystyrene standard. The weight average molecular weight was 88,000.

### Preparation Example 2

In a 0.5-l four-neck flask equipped with a thermometer, a stirrer, a nitrogen introduction tube and a reflux condenser with an oil/water separator, 45.92 g (112 mmol) of BAPPwas added with 50 g of NMP to dissolve under nitrogen stream. Then, to the reaction mixture was added with 23.576 g (112 mmol) of TAC with cooling not to over 20° C. After stirring for an hour at room temperature, to the reaction mixture was added with 13.5744 g (134.4 mmol) of TEA with cooling not to over 20° C., and reacted for 3 hours at room temperature to produce a polyamic acid varnish. The resultant polyamic acid varnish was further subjected to dehydration reaction for 3 hours at 190° C. to produce a polyamideimide resin varnish. This polyamideimide resin varnish was poured into water and the resultant precipitate was separated, milled and dried to give a polyamideimide resin powder (PAI-2) soluble in a polar solvent at room temperature. The resultant polyamideimide resin (PAI-2) was measured for a weight average molecular weight by using a GPC based on a polystyrene standard. The weight average molecular weight was 68,000.

### Preparation Example 3

In a 0.5-l four-neck flask equipped with a thermometer, a stirrer, a nitrogen introduction tube and a reflux condenser with an oil/water separator, 45.92 g (112 mmol) of BAPP was added with 50 g of NMP to dissolve under nitrogen stream. Then, to the reaction mixture was added with 14.1456 g (67.2 mmol) of TAC and 14.4256 g (44.8 mmol) of 3,4,3′,4′-benzophenone tetracarboxylic dianhydride (hereinafter, abbreviated to BTDA) with cooling not to over 20° C. After stirring for an hour at room temperature, to the reaction mixture was added with 8.145 g (80.64 mmol) of TEA with cooling not to over 20° C., and reacted for 3 hours at room temperature to produce a polyamic acid varnish. The resultant polyamic acid varnish was further subjected to dehydration reaction for 6 hours at 190° C. to produce a polyamideimide resin varnish. This polyamideimide resin varnish was poured into water and the resultant precipitate was separated, milled and dried to give a polyamideimide resin powder (PAI-3) insoluble in a polar solvent at room temperature but soluble by heating. The resultant polyamideimide resin (PAI-3) was measured for a weight average molecular weight by using a GPC based on a polystyrene standard. The weight average molecular weight was 90,000.

### Preparation Example 4

In a 0.5-l four-neck flask equipped with a thermometer, a stirrer, a nitrogen introduction tube and a reflux condenser with an oil/water separator, 45.92 g (112 mmol) of BAPP was added with 50 g of NMP to dissolve under nitrogen stream. Then, to the reaction mixture was added with 14.1456 g (67.2 mmol) of TAC and 14.4256 g (44.8 mmol) of BTDA with cooling not to over 20° C. After stirring for an hour at room temperature, to the reaction mixture was added with 8.145 g (80.64 mmol) of TEA with cooling not to over 20° C., and reacted for 3 hours at room temperature to produce a polyamic acid varnish. The resultant polyamic acid varnish was further subjected to dehydration reaction for 3 hours at 190° C. to produce a polyamideimide resin varnish. This polyamideimide resin varnish was poured into water and the resultant precipitate was separated, milled and dried to give a polyamideimide resin powder (PAI-4) insoluble in a polar solvent at room temperature but soluble by heating. The resultant polyamideimide resin (PAI-4) was measured for a weight average molecular weight by using a GPC based on a polystyrene standard. The weight average molecular weight was 60,000.

### <Production of Resin Composition>

### Production Example 1

In a 1-little four-neck flask equipped with a thermometer, a stirrer, a nitrogen introduction tube and a reflux condenser, 110 g of polyamideimide resin powder (PAI-1) obtained in PREPARATION EXAMPLE 1, which is soluble at room temperature, 33 g of polyamideimide resin powder (PAI-3) obtained in PREPARATION EXAMPLE 3, which is insoluble in a polar solvent at room temperature but soluble by heating, 300 g of γ-butyrolactone (hereinafter, abbreviated to γ-BL) and 129 g of triethylene glycol dimethyl ether (hereinafter, abbreviated to DMTG) were stirred and heated to 130° C. under nitrogen stream. After stirring for 2 hours at 130° C., heating was halted, and the reaction mixture was allowed to cool to room temperature with stirring to give a yellow resin composition. The resultant yellow resin composition was added with 61.3 g of TREFIL E-601 (trade name of silicone rubber powder manufactured by Dow Corning Toray Silicone Co., Ltd., average particle diameter: approximately 2 μm, particle diameter distribution 1 to 10 μm, abbreviated to E-601 hereinafter) and kneaded with a planetary mixer into a dispersion. The dispersion was filled into a filtration device KST-47 (Advantec Toyo Kabushiki Kaisha), and pressure-filtered with a pressure of 3.0 kg/cm² by inserting a silicon rubber piston into the device to give a resin composition (P-1). A few grams of the resulting resin composition was weighed on a metal dish, and measured for a nonvolatile matter concentration (hereinafter, abbreviated to NV) under the following conditions. Composition and characteristics are summarized in Table 1.

NV(%)=(volume of resin composition after heat-drying (g)/volume of resin composition before heat-drying (g))×100

drying conditions: 1 hour at 150° C.+2 hours at 250° C.

### Production Example 2

In a 1-little four-neck flask equipped with a thermometer, a stirrer, a nitrogen introduction tube and a reflux condenser, 110 g of polyamideimide resin powder (PAI-2) obtained in PREPARATION EXAMPLE 2, which is soluble at room temperature, 33 g of polyamideimide resin powder (PAI-3) obtained in PREPARATION EXAMPLE 3, which is insoluble in a polar solvent at room temperature but soluble by heating, 300 g of γ-BL and 129 g of DMTG were stirred and heated to 130° C. under nitrogen stream. After stirring for 2 hours at 130° C., heating was halted, and the reaction mixture was allowed to cool to room temperature with stirring to give a yellow resin composition. The resultant yellow resin composition was added with 61.3 g of E-601 and kneaded with a planetary mixer into a dispersion. The dispersion was filled into a filtration device KST-47 (Advantec Toyo Kabushiki Kaisha), and pressure-filtered with a pressure of 3.0 kg/cm² by inserting a silicon rubber piston into the device to give a resin composition (P-2). The resulting resin composition was measured for a NV similarly as in PRODUCTION EXAMPLE 1.

Composition and characteristics are summarized in Table 1.

### Production Example 3

In a 1-little four-neck flask equipped with a thermometer, a stirrer, a nitrogen introduction tube and a reflux condenser, 110 g of polyamideimide resin powder (PAI-1) obtained in PREPARATION EXAMPLE 1, which is soluble at room temperature, 33 g of polyamideimide resin powder (PAI-4) obtained in PREPARATION EXAMPLE 4, which is insoluble in a polar solvent at room temperature but soluble by heating, 300 g of γ-BL and 129 g of DMTG were stirred and heated to 130° C. under nitrogen stream. After stirring for 2 hours at 130° C., heating was halted, and the reaction mixture was allowed to cool to room temperature with stirring to give a yellow resin composition. The resultant yellow resin composition was added with 61.3 g of E-601 and kneaded with a planetary mixer into a dispersion. The dispersion was filled into a filtration device KST-47 (Advantec Toyo Kabushiki Kaisha), and pressure-filtered with a pressure of 3.0 kg/cm² by inserting a silicon rubber piston into the device to give a resin composition (P-3). The resulting resin composition was measured for a NV similarly as in PRODUCTION EXAMPLE 1. Composition and characteristics are summarized in Table 1.

### Production Example 4

In a 1-little four-neck flask equipped with a thermometer, a stirrer, a nitrogen introduction tube and a reflux condenser, 110 g of polyamideimide resin powder (PAI-2) obtained in PREPARATION EXAMPLE 2, which is soluble at room temperature, 33 g of polyamideimide resin powder (PAI-4) obtained in PREPARATION EXAMPLE 4, which is insoluble in a polar solvent at room temperature but soluble by heating, 300 g of γ-BL and 129 g of DMTG were stirred and heated to 130° C. under nitrogen stream. After stirring for 2 hours at 130° C., heating was halted, and the reaction mixture was allowed to cool to room temperature with stirring to give a yellow resin composition. The resultant yellow resin compositionwas added with 61.3 g of E-601 and kneaded with a planetary mixer into a dispersion. The dispersion was filled into a filtration device KST-47 (Advantec Toyo Kabushiki Kaisha), and pressure-filtered with a pressure of 3.0 kg/cm² by inserting a silicon rubber piston into the device to give a resin composition (P-4). The resulting resin composition was measured for a NV similarly as in PRODUCTION EXAMPLE 1. Composition and characteristics are summarized in Table 1.

### Production Example 5

A resin composition (P-5) was obtained similarly as in PRODUCTION EXAMPLE 1, except that TREFIL E-600 (trade name of silicone rubber powder manufactured by Dow Corning ToraySilicone Co., Ltd., average particle diameter: approximately 2 μm, particle diameter distribution 1 to 10 μm, abbreviated to E-600 hereinafter), which is not chemically modified on the surface thereof, was used instead of TREFIL E-601 in PRODUCTION EXAMPLE 1. The resulting resin composition was measured for a NV similarly as in PRODUCTION EXAMPLE 1. Composition and characteristics are summarized in Table 1.

### Production Example 6

A resin composition (P-6) was obtained similarly as in PRODUCTION EXAMPLE 1, except that TREFIL R-902A (trade name of silicone rubber powder manufactured by Dow Corning Toray Silicone Co., Ltd., average particle diameter: approximately 8 μm, particle diameter distribution 1 to 30 μm, abbreviated to R-902A hereinafter) was used instead of TREFIL E-601 in PRODUCTION EXAMPLE 1. The resulting resin composition was measured for a NV similarly as in PRODUCTION EXAMPLE 1. Composition and characteristics are summarized in Table 1.

TABLE 1

| | | | PRODUCTION | PRODUCTION | PRODUCTION | PRODUCTION | PRODUCTION | PRODUCTION |
|---|---|---|---|---|---|---|---|---|
| item | | | EXAMPLE 1 | EXAMPLE 2 | EXAMPLE 3 | EXAMPLE 4 | EXAMPLE 5 | EXAMPLE 6 |
| resin composition | | | P-1 | P-2 | P-3 | P-4 | P-5 | P-6 |
| component | A | PAI-1 | 110 | — | 110 | — | 110 | 110 |
| composition | | PAI-2 | — | 110 | — | 110 | — | — |
| (g) | B | PAI-3 | 33 | 33 | — | — | 33 | 33 |
| | | PAI-4 | — | — | 33 | 33 | — | — |
| | C | E-601 | 61.3 | 61.3 | 61.3 | 61.3 | — | — |
| | | E-600 | — | — | — | — | 61.3 | — |
| | | R-902A | — | — | — | — | — | 61.3 |
| | D | Υ-BL | 300 | 300 | 300 | 300 | 300 | 300 |
| | | DMTG | 129 | 129 | 129 | 129 | 129 | 129 |

| | | | | | | |
|---|---|---|---|---|---|---|
| NV(%) | About 32 | About 32 | About 32 | About 32 | About 32 | About 32 |

### Example 1

To 100 g of resin composition (P-1) obtained in PRODUCTION EXAMPLE 1 was added with 18 g of 1,3-dimethyltetrahydro-2(1H)-pyrimidinone (hereinafter, abbreviated to DMPU), and defoamed by a rotation-and-revolution-type vacuum defoamer (manufactured by Japan Applied Technology Inc., AR-360M model) to give a resin composition (P-7).

### <Rheological Property>

The resultant resin composition (P-7) was measured for a viscosity (rheological property) thereof. In the measurement, a rheometer, CSR-10 model manufactured by BOHLIN INSTRUMENTS was used, and the resin composition was loaded with 13 Pa of shear stress for 60 seconds and then measured with varying a frequency from 50 Hz to 5 Hz under a fixed shear stress of 13 Pa. During the measurement, a number of sampling points was 15, and each of measurement waiting times was 30 seconds. Results are listed in Table 2.

### <Paste Property>

The resultant resin composition (P-7) was used for printing on a semiconductor substrate having a wiring and a copper post formed thereon (pitch dimension: 5.3 mm×6.3 mm, scribing line 100 μm, copper post diameter: 300 μm, copper post height: 100 μm) by using a screen printer (Newlong Seimitsu Kogyo Co., Ltd., LS-34GX attached with an alignment device), a laser etching metal plate made of nickel alloy (Process Lab. Micron Co., Ltd., thickness: 200 μm, opening dimension: 5 mm×6 mm, pitch dimension: 5.3 mm×6.3 mm) and a nylon J squeegee (Newlong Seimitsu Kogyo Co., Ltd.), and printability (paste property) thereof was evaluated.

Evaluation was conducted by an optical microscopic examination of paste embedding property in the wiring and shape retention after printing according to the following rating. Results are listed in Table 2.

### (Paste Embedding Property in the Wiring and the Copper Post)

⊚: no void occurred due to defective embedding
◯: a small number of voids occurred due to defective embedding (void rate: less than 10% of the total copper post)
Δ: a certain number of voids occurred due to defective embedding (void rate: 10-50% of the total copper post)
X: voids occurred due to defective embedding over the almost entire substrate (void rate: more than 50% of the total copper post)
⊚ and ◯ are accepted
   (Shape Retention after Printing)
⊚: a scribing line was formed
◯: a scribing line was formed with minor flowing
Δ: a scribing line was partially collapsed
X: a scribing line was collapsed (over the almost entire substrate)
⊚ and ◯ are accepted

The resultant resin composition (P-7) was also measured for a NV similarly as in PRODUCTION EXAMPLE 1. Result is listed in Table 2.

### <Film Property>

The resultant resin composition (P-7) was coated on a Teflon (registered trade name) substrate and heated to 250° C. to evaporate an organic solvent, and thereby a film having a thickness of 25 μm was formed. This film was attached to a dynamic viscoelastic spectrometer (manufactured by K.K. Iwamoto Seisakusho) and measured for a tensile elastic modulus (25° C., 10 Hz) and a glass transition temperature (frequency: 10 Hz, temperature raising rate: 2° C./min). A heat decomposition starting temperature was also measured by using a thermobalance at a temperature raising rate of 10° C./min in air. Results are listed in Table 2.

### <Production and Evaluation of a Semiconductor Device>

The resultant resin composition (P-7) was subjected to the steps of coating it several times on a semiconductor substrate having a wiring formed thereon by screen printing and then drying to form a resin layer; forming a rewiring on the resin layer, which is in electrical communication with an electrode on the semiconductor substrate; forming a protective layer on the rewiring; forming an external electrode terminal on the protective layer; and dicing, and thereby a semiconductor device was produced.

The semiconductor device was subjected to a heat cycle test (cycle of −55° C./30 min and 125° C./30 min, 1000 times) for testing whether crack is formed on the resin layer or not. Result is listed in Table 2. In the Table, when a description of a test result is, for example, “1/10”, it means that there was one crack in ten samples.

### Example 2

A resin composition (P-8) and a semiconductor device were produced similarly as in Example 1, except that the resin composition (P-5) obtained in PRODUCTION EXAMPLE 5 was used instead of the resin composition (P-1) used in Example 1. The resultant resin composition (P-8) and the resultant semiconductor device were examined and evaluated similarly as in Example 1. Results are listed in Table 2.

### Example 3

A resin composition (P-9) and a semiconductor device were produced similarly as in Example 1, except that an amount of added DMPU was 25 g differing from Example 1. The resultant resin composition (P-9) and the resultant semiconductor device were examined and evaluated similarly as in Example 1. Results are listed in Table 2.

### Example 4

A resin composition (P-10) and a semiconductor device were produced similarly as in Example 1, except that an amount of added DMPU was 35.5 g differing from Example 1. The resultant resin composition (P-10) and the resultant semiconductor device were examined and evaluated similarly as in Example 1. Results are listed in Table 2.

### Example 5

A resin composition (P-11) and a semiconductor device were produced similarly as in Example 1, except that the resin composition (P-2) obtained in PRODUCTION EXAMPLE 2 was used instead of the resin composition (P-1) used in Example 1, and an amount of added DMPU was 8 g. The resultant resin composition (P-11) and the resultant semiconductor device were examined and evaluated similarly as in Example 1. Results are listed in Table 2.

### Example 6

A resin composition (P-12) and a semiconductor device were produced similarly as in Example 5, except that an amount of added DMPU was 16 g differing from Example 5. The resultant resin composition (P-12) and the resultant semiconductor device were examined and evaluated similarly as in Example 1. Results are listed in Table 2.

### Example 7

A resin composition (P-13) and a semiconductor device were produced similarly as in Example 5, except that an amount of added DMPU was 25 g differing from Example 5. The resultant resin composition (P-13) and the resultant semiconductor device were examined and evaluated similarly as in Example 1. Results are listed in Table 2.

### Example 8

A resin composition (P-14) and a semiconductor device were produced similarly as in Example 1, except that the resin composition (P-3) obtained in PRODUCTION EXAMPLE 3 was used instead of the resin composition (P-1) used in Example 1, and an amount of added DMPU was 16 g. The resultant resin composition (P-14) and the resultant semiconductor device were examined and evaluated similarly as in Example 1. Results are listed in Table 2.

### Example 9

A resin composition (P-15) and a semiconductor device were produced similarly as in Example 1, except that the resin composition (P-4) obtained in PRODUCTION EXAMPLE 4 was used instead of the resin composition (P-1) used in Example 1, and an amount of added DMPU was 8 g. The resultant resin composition (P-15) and the resultant semiconductor device were examined and evaluated similarly as in Example 1. Results are listed in Table 2.

### Example 10

A resin composition (P-16) and a semiconductor device were produced similarly as in Example 9, except that an amount of added DMPU was 16 g differing from Example 9. The resultant resin composition (P-16) and the resultant semiconductor device were examined and evaluated similarly as in Example 1. Results are listed in Table 2.

### Comparative Example 1

A semiconductor device was produced similarly as in Example 1, except that the resin composition (P-1) obtained in PRODUCTION EXAMPLE 1 was used without modification instead of the resin composition (P-7) used in Example 1. The resin composition (P-1) and the resultant semiconductor device were examined and evaluated similarly as in Example 1. Results are listed in Table 2.

### Comparative Example 2

A resin composition (P-17) and a semiconductor device were produced similarly as in Example 1, except that an amount of added DMPU was 8 g differing from Example 1. The resultant resin composition (P-17) and the resultant semiconductor device were examined and evaluated similarly as in Example 1. Results are listed in Table 2.

### Comparative Example 3

A resin composition (P-18) and a semiconductor device were produced similarly as in Example 1, except that an amount of added DMPU was 48 g differing from Example 1. The resultant resin composition (P-18) and the resultant semiconductor device were examined and evaluated similarly as in Example 1. Results are listed in Table 2.

### Comparative Example 4

A resin composition (P-19) and a semiconductor device were produced similarly as in Example 9, except that an amount of added DMPU was 35.5 g differing from Example 9. The resultant resin composition (P-19) and the resultant semiconductor device were examined and evaluated similarly as in Example 1. Results are listed in Table 2.

### Comparative Example 5

In a 1-little four-neck flask equipped with a thermometer, a stirrer, a nitrogen introduction tube and a reflux condenser, 110 g of polyamideimide resin powder (PAI-1) obtained in PREPARATION EXAMPLE 1, which is soluble at room temperature, 300 g of γ-BL and 129 g of DMTG were stirred and heated to 130° C. under nitrogen stream. After stirring for 2 hours at 130° C., heating was halted, and the reaction mixture was allowed to cool to room temperature with stirring to give a yellow resin composition. The resultant yellow resin composition was added with 61.3 g of E-601 and kneaded with a planetary mixer into a dispersion. The dispersion was filled into a filtration device KST-47 (Advantec Toyo Kabushiki Kaisha), and pressure-filtered with a pressure of 3.0 kg/cm² by inserting a silicon rubber piston into the device, and defoamed by a rotation-and-revolution-type vacuum defoamer (Japan Applied Technology Inc., AR-360M model) to give a resin composition (P-20). A semiconductor device was produced similarly as in Example 1, except that the resultant resin composition (P-20) was used instead of the resin composition (P-7) used in Example 1. The resultant resin composition (P-20) and the resultant semiconductor device were examined and evaluated similarly as in Example 1. Results are listed in Table 2.

### Comparative Example 6

In a 1-little four-neck flask equipped with a thermometer, a stirrer, a nitrogen introduction tube and a reflux condenser, 110 g of polyamideimide resin powder (PAI-1) obtained in PREPARATION EXAMPLE 1, which is soluble at room temperature, 33 g of polyamideimide resin powder (PAI-3) obtained in PREPARATION EXAMPLE 3, which is insoluble in a polar solvent at room temperature but soluble by heating, 300 g of γ-BL and 129 g of DMTG were stirred and heated to 130° C. under nitrogen stream. After stirring for 2 hours at 130° C., heating was halted, and the reaction mixture was allowed to cool to room temperature with stirring to give a yellow resin composition. The resultant yellow resin composition was filled into a filtration device KST-47 (Advantec Toyo Kabushiki Kaisha), and pressure-filtered with a pressure of 3.0 kg/cm² by inserting a silicon rubber piston into the device, and defoamed by a rotation-and-revolution-type vacuum defoamer (Japan Applied Technology Inc., AR-360M model) to give a resin composition (P-21). A semiconductor device was produced similarly as in Example 1, except that the resultant resin composition (P-21) was used instead of the resin composition (P-7) used in Example 1. The resultant resin composition (P-21) and the resultant semiconductor device were examined and evaluated similarly as in Example 1. Results are listed in Table 2.

### Comparative Example 7

A resin composition (P-22) and a semiconductor device were produced similarly as in Example 1, except that the resin composition (P-6) obtained in PRODUCTION EXAMPLE 6 was used instead of the resin composition (P-1) used in Example 1. The resultant resin composition (P-22) and the resultant semiconductor device were examined and evaluated similarly as in Example 1. Results are listed in Table 2.

TABLE 2

Example

| item | | | 1 | 2 | 3 | 4 | 5 | 6 | 7 | 8 | 9 |
|---|---|---|---|---|---|---|---|---|---|---|---|
| resin | A | PAI-1 | 110 | 110 | 110 | 110 | — | — | — | 110 | — |
| composition | | PAI-2 | — | — | — | — | 110 | 110 | 110 | | 110 |
| (g) | B | PAI-3 | 33 | 33 | 33 | 33 | 33 | 33 | 33 | — | — |
| | | PAI-4 | — | — | — | — | — | — | — | 33 | 33 |
| | C | E-601 | 61.3 | — | 61.3 | 61.3 | 61.3 | 61.3 | 61.3 | 61.3 | 61.3 |
| | | E-600 | — | 61.3 | — | — | — | — | — | — | — |
| | | R-902A | — | — | — | — | — | — | — | — | — |
| | D | γ-BL | 300 | 300 | 300 | 300 | 300 | 300 | 300 | 300 | 300 |
| | | DMTG | 129 | 129 | 129 | 129 | 129 | 129 | 129 | 129 | 129 |
| | | DMPU^{1} | 18 | 18 | 25 | 35.5 | 8 | 16 | 25 | 16 | 8 |

| resin composition name | | | P-7 | P-8 | P-9 | P-10 | P-11 | P-12 | P-13 | P-14 | P-15 |
|---|---|---|---|---|---|---|---|---|---|---|---|
| rheological | Viscosity | 5 Hz | 193 | 190 | 139 | 54 | 202 | 78 | 36 | 83 | 168 |
| property | (Pa · s) | 50 Hz | 56 | 58 | 42 | 15 | 71 | 25 | 13 | 26 | 58 |
| | | 5 Hz/50 Hz | 3.45 | 3.28 | 3.31 | 3.60 | 2.85 | 3.12 | 2.77 | 3.19 | 2.90 |

| | | | | | | | | | | |
|---|---|---|---|---|---|---|---|---|---|---|
| paste | embedding | ◯ | ◯ | ⊚ | ⊚ | ◯ | ⊚ | ⊚ | ⊚ | ◯ |
| properties | property | | | | | | | | | |
| | shape | ⊚ | ⊚ | ⊚ | ◯ | ⊚ | ◯ | ◯ | ◯ | ⊚ |
| | retention | | | | | | | | | |
| | NV (%) | 27.5 | 27.5 | 26.2 | 24.1 | 30.2 | 28.1 | 26.3 | 28.2 | 29.9 |
| film | tensile elastic | 0.9 | 0.9 | 0.9 | 0.9 | 0.9 | 0.9 | 0.9 | 0.9 | 0.9 |
| properties | modulus (GPa) | | | | | | | | | |
| | glass transition | 210 | 210 | 210 | 210 | 200 | 200 | 200 | 200 | 200 |
| | temperature (° C.) | | | | | | | | | |
| | heat decomposition | 430 | 420 | 430 | 430 | 420 | 420 | 420 | 420 | 415 |
| | starting | | | | | | | | | |
| | temperature (° C.) | | | | | | | | | |

| | | | | | | | | | |
|---|---|---|---|---|---|---|---|---|---|
| rating of a semiconductor device | 0/10 | 1/10 | 0/10 | 0/10 | 0/10 | 0/10 | 0/10 | 0/10 | 0/10 |

| | |
|---|---|
| Example | Comparative Example |

| item | | | 10 | 1 | 2 | 3 | 4 | 5 | 6 | 7 |
|---|---|---|---|---|---|---|---|---|---|---|
| resin | A | PAI-1 | — | 110 | 110 | 110 | — | 110 | 110 | 110 |
| composition | | PAI-2 | 110 | — | — | — | 110 | — | — | — |
| (g) | B | PAI-3 | — | 33 | 33 | 33 | — | — | 33 | 33 |
| | | PAI-4 | 33 | — | — | — | 33 | — | — | — |
| | C | E-601 | 61.3 | 61.3 | 61.3 | 61.3 | 61.3 | 61.3 | — | — |
| | | E-600 | — | — | — | — | — | — | — | — |
| | | R-902A | — | — | — | — | — | — | — | 61.3 |
| | D | γ-BL | 300 | 300 | 300 | 300 | 300 | 300 | 300 | 300 |
| | | DMTG | 129 | 129 | 129 | 129 | 129 | 129 | 129 | 129 |
| | | DMPU^{1} | 16 | — | 8 | 48 | 35.5 | — | — | 18 |

| resin composition name | | | P-16 | P-1 | P-17 | P-18 | P-19 | P-20 | P-21 | P-22 |
|---|---|---|---|---|---|---|---|---|---|---|
| rheological | Viscosity | 5 Hz | 62 | 754 | 543 | 22 | 7.8 | 188 | 222 | 190 |
| property | (Pa · s) | 50 Hz | 21 | 228 | 178 | 2.8 | 1.8 | 156 | 81 | 61 |
| | | 5 Hz/50 Hz | 2.95 | 3.31 | 3.05 | 7.86 | 4.33 | 1.21 | 2.74 | 3.11 |

| | | | | | | | | | |
|---|---|---|---|---|---|---|---|---|---|
| paste | embedding | ⊚ | X | X | ⊚ | ⊚ | X | ◯ | Δ |
| properties | property | | | | | | | | |
| | shape | ◯ | ⊚ | ⊚ | X | X | ⊚ | ⊚ | ⊚ |
| | retention | | | | | | | | |
| | NV (%) | 28.1 | 32.5 | 30.2 | 22.3 | 24.1 | 27.3 | 24.8 | 27.4 |
| film | tensile elastic | 0.9 | 0.9 | 0.9 | 0.9 | 0.9 | 0.3 | 2.8 | 0.9 |
| properties | modulus (GPa) | | | | | | | | |
| | glass transition | 200 | 210 | 210 | 210 | 200 | 200 | 210 | 200 |
| | temperature (° C.) | | | | | | | | |
| | heat decomposition | 415 | 430 | 430 | 430 | 415 | 410 | 420 | 400 |
| | starting | | | | | | | | |
| | temperature (° C.) | | | | | | | | |

| | | | | | | | | |
|---|---|---|---|---|---|---|---|---|
| rating of a semiconductor device | 0/10 | 10/10 | 6/10 | —^{2} | —^{2} | 8/10 | 10/10 | 5/10 |

^{1}An amount of added DMPU is weight per 100 g of a resin composition (P-1 to P-6) consisting of A component, B component, C component, γ-BL and DMTG.
^{2}A semiconductor device cannot be produced

1. A resin composition comprising (A) an aromatic thermoplastic resin soluble in a polar solvent at room temperature, (B) an aromatic thermoplastic resin not soluble in the polar solvent at room temperature but soluble by heating, (C) a filler having rubber elasticity of which an average particle diameter is 0.1 to 6 μm and a particle diameter distribution is 0.01 to 15 μm and (D) the polar solvent, wherein viscosities of the resin composition measured at frequencies of 5 Hz and 50 Hz under a shear stress of 13 Pa by using a rheometer are less than 400 Pa·s and not less than 3 Pa·s, respectively, and a ratio of those viscosities (viscosity at 5 Hz (Pa·s)/viscosity at 50 Hz (Pa·s)) is not less than 2.

2. The resin composition according to claim 1, wherein (A) the aromatic thermoplastic resin soluble in the polar solvent at room temperature and (B) the aromatic thermoplastic resin not soluble in the polar solvent at room temperature but soluble by heating are polyamide resins, polyimide resins, polyamideimide resins or precursors thereof.

3. The resin composition according to claim 1, wherein the surface of the filler having rubber elasticity is subjected to chemical modification.

4. The resin composition according to claim 3, wherein the chemical modification is modification by an epoxy group.

5. A semiconductor device using the resin composition according to claim 1.

6. The resin composition according to claim 2, wherein the surface of the filler having rubber elasticity is subjected to chemical modification.

7. The resin composition according to claim 6, wherein the chemical modification is modification by an epoxy group.

8. A semiconductor device using the resin composition according to claim 7.

9. A semiconductor device using the resin composition according to claim 2.
